(19) United States
(12) Patent Application Publication
(10) Pub. No.: US 2020/0230004 A1
(43) Pub. Date: Jul. 23, 2020

(54) Person hoisting device and a method for producing motive power of a person hoisting device

(71) Applicant: Kailamed Oy, Oulu (FI)

(72) Inventors: Marko Tapani KAILASUO, Oulu (FI); Salme Annikki NIEMI, Lumijoki (FI)

(73) Assignee: Kailamed Oy, Oulu (FI)

(21) Appl. No.: 16/639,143

(22) PCT Filed: Aug. 30, 2018
(86) PCT No.: PCT/FI2018/050612

§ 371 Date: Feb. 14, 2020

(30) Foreign Application Priority Data
Aug. 30, 2017 (FI) 20175774

(51) Int. Cl. A61G 7/10

(52) U.S. Cl. CPC A61G 7/1059; A61G 7/1092; A61G 7/1076; A61G 7/1019; A61G 7/1011

(57) ABSTRACT

The person hoisting device has a frame (10), a person support which can be moved in relation to the frame, and moving means for moving the person support from a first location in relation to the frame to a second location in relation to the frame along a movement path. The second location is at a distance from the first location. The position of the person support in relation to the frame can be changed, and the moving means are arranged to move the person support in the direction of the movement path when changing the position of the person support in relation to the frame. The person support can comprise a seat (14) and an armrest (16). The moving means can comprise a hydraulic cylinder (22), a hydraulic pump (24) for pumping hydraulic fluid to the hydraulic cylinder, and a lever mechanism between the person support and the hydraulic pump for using the hydraulic pump. In the method, motive power is produced for a person hoisting device, which has a frame, a person support which can be moved in relation to the frame, and moving means for moving the person support from a first location in relation to the frame to a second location in relation to the frame along a movement path, which second location is at a distance from the first location. The motive power of the moving means is produced by changing the position of the person support in relation to the frame.

The invention relates to a person hoisting device, which has a frame, a person support which can be moved in relation to the frame, the position of which person support in relation to the frame can be changed, and moving means for moving the person support from a first location in relation to the frame to a second location in relation to the frame along a movement path, which second location is at a distance from the first location, which moving means are arranged to move the person support in the direction of the movement path when changing the position of the person support in relation to the frame. The invention further relates to a method for producing motive power of the person hoisting device.

Elderly and weak people often want to live at home for as long as possible. For many elderly people, weakened muscle strength of the lower extremities and/or joint damage of the extremities make it difficult to cope at home. Especially challenging are situations, where a weak person falls and cannot get up off the floor on his own. For a weak person, getting up off the floor can be an insurmountable task, even if no particular injuries have been caused by the fall. A person living alone often has to call for help to be lifted up. In the worst-case scenario, calling for help from the floor can be impossible, whereby serious additional consequences can be caused to the fallen from the delay in getting up. Assisting a fallen weak person into a standing position requires a lot of strength from the assistant and a lifting procedure done in a difficult position can cause accidents for both the one who has fallen and the one assisting the fallen.

A mobile lifting seat has been developed for making it easier to get up off the floor, which seat has a vertical frame and a seat plate, which is mobile in relation to the vertical frame. The seat plate is lifted and lowered by means of an electric motor. The lifting seat is installed on the floor so that the seat plate settles very close to the floor surface. The weak fallen person himself sidles or is assisted to sit on the seat plate, whereafter the seat plate is lifted upwards with the electric motor. From the seat plate lifted into the upper position, the person can move into a standing position.

The manufacturing costs of a lifting seat equipped with an electric motor and a battery are large, wherefore acquiring a motorized lifting seat is impossible for many, for economic reasons. Electric motors must be connected to the electricity network with power lines, or lifting seats must be equipped with a chargeable battery. Power lines limit the possibilities of moving the lifting seat, and power lines laying on the floor can cause falling and injuries. With battery-powered lifting seats, one must take care to charge the battery regularly, because if the battery becomes empty, the lifting seat is temporarily unusable. Lifting of the seat plate with the aid of a motor makes the lifting stage prone to accidents, because the motor does not in any way recognize e.g. faulty positions of the limbs of the person being lifted, grabbings, flattenings or a risk of falling. Additionally, elderly people using the seat often have slow reactivity, which lessens their chances of reacting to possible accident risks in time.

An object of the invention is to provide a person hoisting device and a method for producing motive power of a person hoisting device, with which problems related to prior art can be reduced. The objects of the invention are obtained with a person hoisting device and a method, which are characterised in what is presented in the independent claims. Some advantageous embodiments of the invention are presented in the dependent claims.

The invention relates to a person hoisting device, which has a frame, a person support which can be moved in relation to the frame, and moving means for moving the person support from a first location in relation to the frame to a second location in relation to the frame along a movement path. The second location is at a distance from the first location. The position of the person support in relation to the frame can be changed, and the moving means are arranged to move the person support in the direction of the movement path when changing the position of the person support in relation to the frame. The person support comprises an auxiliary frame supported on the frame in a moveable manner and a rocker shaft supported on the auxiliary frame in a rotating manner, to which rocker shaft the person support is attached. The position of the person support in relation to the frame is thus changed by tilting the person support, whereby the person support rotates around an axis parallel to the rocker shaft.

In one advantageous embodiment of the person hoisting device according to the invention, said person support comprises a seat. The person using the person hoisting device settles to sit on the seat, whereafter the seat is moved along the movement path. The person sitting on the seat can tilt the seat by moving his centre of gravity from the first side of the seat to the second side. Alternatively or additionally, the person support can comprise an armrest.

In a second advantageous embodiment of the person hoisting device according to the invention, the movement path of the person support is substantially straight, and the rocker shaft is substantially perpendicular to the direction of the movement path. Advantageously the rocker shaft is in a substantially horizontal position, when the person hoisting device is in the use position.

In still another advantageous embodiment of the person hoisting device according to the invention, the person support has a width direction, and the rocker shaft is beneath the person support substantially in the middle of the person support, when the person hoisting device is in the use position.

Still another advantageous embodiment of the person hoisting device according to the invention further comprises a limiter for limiting the rotation of the rocker shaft. The limiter prevents the person support from tilting so much that it would be difficult or uncomfortable to be on the person support. Tilting of the person support, such as the seat, can be limited for example to five, eight or ten degrees from the horizontal direction. Advantageously, the person hoisting device further comprises a locking means for locking the person support in an immobile manner to the auxiliary frame. When the person support is supported in an immobile position, the person hoisting device can be used as a chair.

In still another advantageous embodiment of the person hoisting device according to the invention, said moving means comprise a hydraulic cylinder, which is attached by its first end to the frame and by its second end to the auxiliary frame, a hydraulic pump for pumping hydraulic fluid to the hydraulic cylinder, and a lever mechanism between the person support and the hydraulic pump for using the hydraulic pump by changing the position of the person support.

In still another advantageous embodiment of the person hoisting device according to the invention, said moving means comprise a gear rack, which is attached by its first end to the frame, and at least one elevator arm, which has a first end, by which it is attached to the auxiliary frame, and a second end, which has a gripping point attaching to the gear rack.

In the method according to the invention, motive power for a person hoisting device is produced, which person hoisting device has a frame, a person support which can be moved in relation to the frame, and moving means for moving the person support from a first location in relation to the frame to a second location in relation to the frame along a movement path, which second location is at a distance from the first location. In the method the motive power of the moving means is produced by changing the position of the person support in relation to the frame. The person hoisting device comprises an auxiliary frame which can be moved in relation to the frame, a rocker shaft supported on the auxiliary frame in a rotating manner, to which rocker shaft the person support is attached, and the motive power of the person hoisting device is produced by tilting the person support back and forth. Tilting the person support puts the rocker shaft in a back-and-forth rotating motion, which is converted into motive power for the moving means.

In another advantageous embodiment of the method according to the invention, said moving means comprise a hydraulic cylinder, which is attached by its first end to the frame and by its second end to the auxiliary frame, and a hydraulic pump for pumping hydraulic fluid to the hydraulic cylinder. In the method the hydraulic pump is used by changing the position of the person support in relation to the frame. The position of the person support is advantageously changed by moving the centre of gravity of the person supported on the person support in relation to the person support.

An advantage of the person hoisting device according to the invention is that its manufacturing and use costs are inexpensive.

A further advantage of the invention is that its use is not dependent on the availability of electricity.

A further advantage of the invention is that it is safe to use.

Still a further advantage of the invention is that it improves the possibilities for debilitated people to manage at home independently and reduces the need for assistants.

Yet a further advantage of the invention is that it helps its users maintain their physical functionality.

In the following, the invention will be described in detail. In the description, reference is made to the enclosed drawings, in which

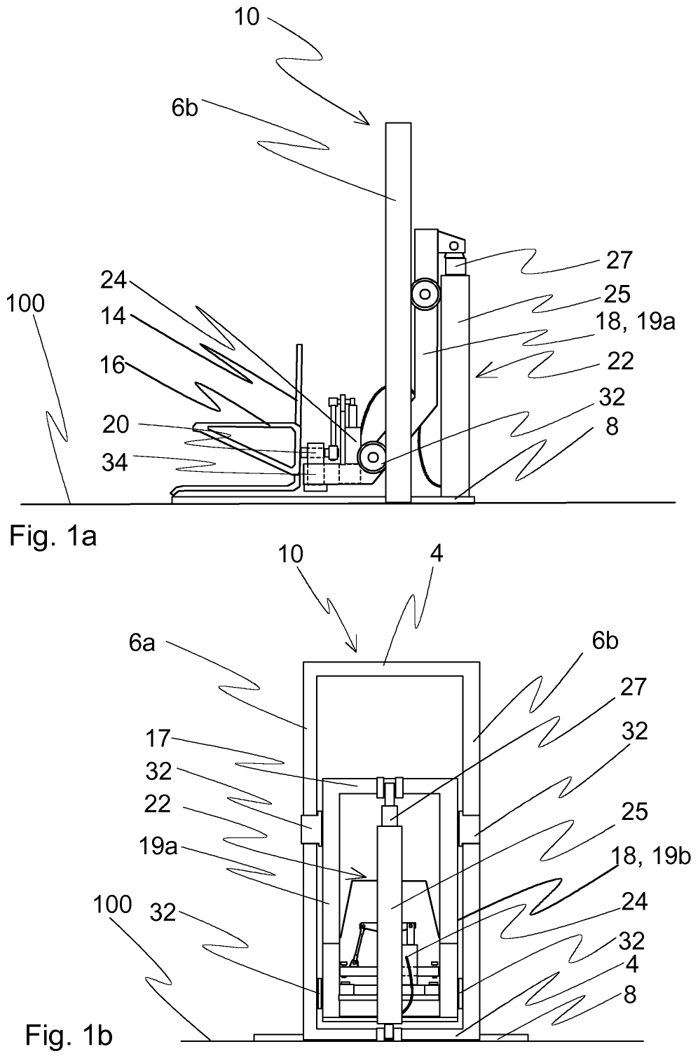

FIG. 1a shows as an example a person hoisting device according to the invention seen from the side,

FIG. 1b shows the person hoisting device shown in FIG. 1a seen from behind,

FIG. 1c shows the person hoisting device shown in FIGS. 1a and 1b seen from the side,

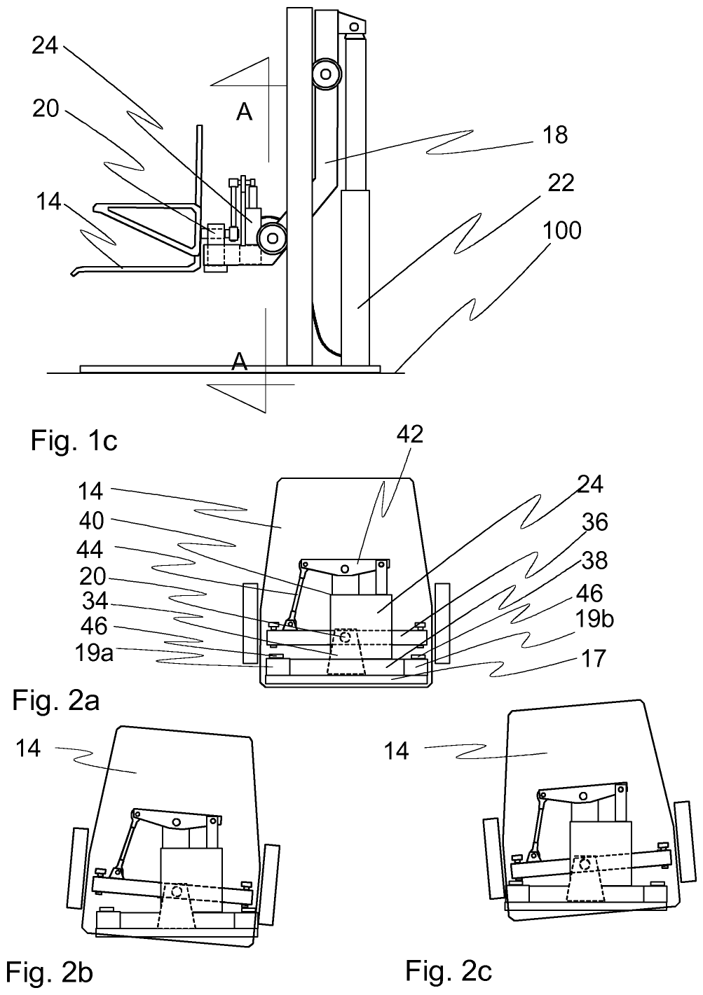

FIGS. 2a-2c show a part of the person hoisting device shown in FIG. 1c seen from behind,

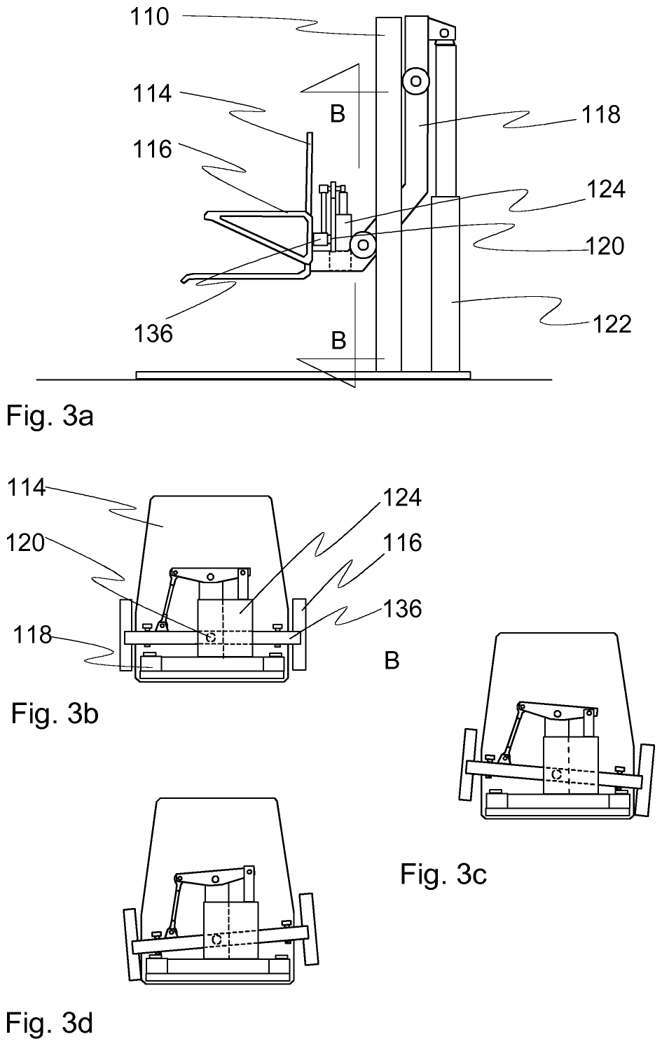

FIG. 3a shows an advantageous embodiment of a person hoisting device according to the invention seen from the side,

FIGS. 3b-3d show a part of the embodiment of the person hoisting device shown in FIG. 3a seen from behind and

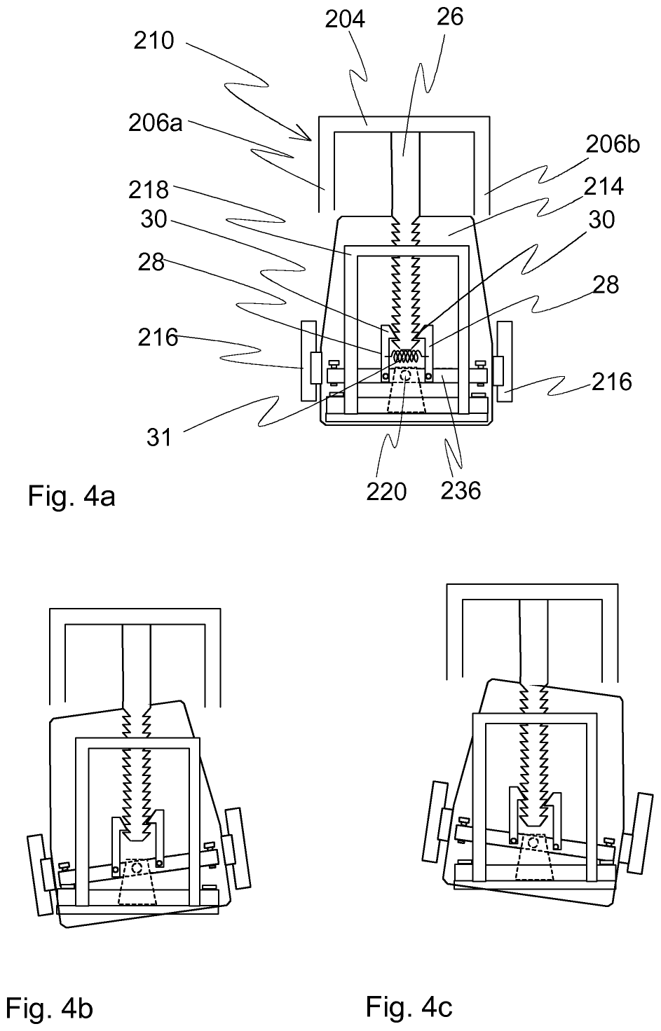

FIGS. 4a-4c show a part of a second advantageous embodiment of the person hoisting device according to the invention seen from behind.

FIGS. 1a and 1c show as an example a person hoisting device according to the invention seen from the side and FIG. 1b shows the same person hoisting device seen from behind. In FIGS. 1a and 1b the seat 14 belonging to the person hoisting device is in the lowered position, and in FIG. 1c the seat is in the raised position. In the following all the figures are described simultaneously.

The person hoisting device has a frame 10, which comprises a leg part 8 to be set on the surface of a base 100 and two parallel edge pillars supported on the leg part, a first edge pillar 6a and a second edge pillar 6b. The edge pillars are connected by their ends to each other with parallel end beams 4. The leg part, edge pillars and end beams are metallic pieces, which are attached together by welding or with bolt fastening. The leg part comprises shaped beam-like parts, which settle on the base in the direction of the base. The edge pillars are attached to the leg part substantially in a right angle, so that the edge pillars 6a, 6b of the frame 10 on the substantially horizontal base are substantially in a vertical position. The frame is designed to be free-standing, i.e. when installed on a substantially horizontal base 100, such as a floor, the frame stays in a vertical position without other support parts or attaching to other structural parts. The leg part can have wheels, on which the person hoisting device can be moved on the base (wheels are not shown in the figure).

An auxiliary frame 18 has been supported on the frame 10 in a moveable manner, which auxiliary frame has two side supports; a first side support 19a and a second side support 19b. The side supports are shaped beam-like parts, which have a vertical section substantially in the direction of the edge pillars, a horizontal section substantially in the direction of the leg part 8, and a corner section connecting the vertical section and horizontal section together. The corner section forms an approximately 45-degree angle with the vertical section and horizontal section. The free ends of the horizontal sections and the free ends of the vertical sections of the side supports are connected together with connecting beams 17. The auxiliary frame is placed between the edge pillars, so that the horizontal sections of the side supports settle on the first side of the edge pillars and the vertical sections on the second side of the edge pillars. Two support rollers 32 are attached on bearings to each of the side supports 19a, 19b. The first support roller is near the junction between the horizontal section and corner section on the first side of the edge pillar 6a, 6b, and the second support roller 32 is on the side surface of the vertical section on the second side of the edge pillar. The auxiliary frame is supported via the support rollers to the edge pillars, so that the support rollers on the same side support roll along opposite side surfaces of the edge pillars. The edge pillars of the frame thus form a linear movement path, along which the auxiliary frame can move back and forth as controlled by the support rollers.

A bearing housing 34 is attached to the connecting beam 17 which connects the ends of the horizontal sections of the side supports 19a, 19b, through which bearing housing the rocker shaft 20 passes. The rocker shaft is substantially in a perpendicular position in relation to the plane defined by the edge pillars 6a, 6b, so in the person hoisting device set on a horizontal base the rocker shaft is substantially horizontal. A seat 14 is attached to the first end of the rocker shaft, which seat comprises a sitting level in the direction of the leg part and a backrest turning in an angle from the plane of the leg part. Two armrests 16 are attached to the backrest, so that they settle on opposite edges of the sitting level. In this description, person support is used as a general term for the seat and armrest. The rocker shaft can rotate around its axis in the bearing housing, whereby the seat and the thereto attached armrests tilt sideways in the rotational direction of the rocker shaft.

On the second side of the edge pillars there is a hydraulic cylinder 22, which comprises a cylinder pipe 25 and a piston rod 27 pushing out from inside the cylinder pipe. The cylinder pipe is attached by its first end to the leg part 8 and the free end of the piston rod is attached to the connecting beam 17 connecting the ends of the vertical sections of the auxiliary frame 18, so that the hydraulic cylinder settles substantially in a parallel position with the edge pillars. On top of the connecting beam connecting the horizontal sections of the side supports there is a hydraulic pump 24, from which a hydraulic pipe leads to a cylinder pipe 25 of a hydraulic cylinder 22. The hydraulic pump is connected with a lever mechanism to the second end of the rocker shaft 20, so that the back-and-forth rotation of the rocker shaft makes the hydraulic pump pump hydraulic fluid into the hydraulic cylinder 22.

In FIGS. 1a and 1b the seat 14 of the person hoisting device is at the first end position of its movement path, very close to the surface of the base 100. Tilting the seat sideways from one side to the other puts the rocker shaft 20 in a back-and-forth rotational motion, whereby the hydraulic pump 24 pumps hydraulic fluid to the hydraulic cylinder 22, whereby it grows in length. A hydraulic cylinder growing in length lifts the auxiliary frame 18 and thereto supported seat 14 upwards along the movement path defined by the edge pillars 6a, 6b into the position according to FIG. 1c. The auxiliary frame and seat rise for as long as the sideways rocking movement is done with the seat. In connection with the seat there is a locking member, with which the seat can if so desired be locked into an immobile position in relation to the auxiliary frame (locking member is not shown in the figures). In connection with the hydraulic pump or hydraulic cylinder there is a pressure release member, by using which the hydraulic fluid can be released to flow out of the cylinder pipe into a hydraulic fluid container in connection with the hydraulic pump, whereby the auxiliary frame 18 and thereto attached seat descend due to gravity slowly into the lower position according to FIG. 1a.

FIGS. 2a, 2b and 2c show as an example a person hoisting device according to the invention as cut along sectional line AA of FIG. 1c. FIG. 2a shows the ends of the horizontal sections of the side supports 19a, 19b of the auxiliary frame and the connecting beam 17 and intermediate beam 38 connecting them. On the upper surface of the connecting beam there is a bearing housing 34, through which the rocker shaft 20 passes. The first end of the rocker shaft is attached to the backrest of the seat 14, and the second end of the rocker shaft is attached in an unrotatable manner to the middle part of the horizontal rod 36. A vertical post 40 is attached to the intermediate beam, in the end of which post there is a horizontal upper rod 42. The upper rod is attached to the end of the post in a turnable manner with a pivot pin. The first end of the upper rod is connected to the first end of the horizontal rod with a stiff rod 44. The second end of the upper rod is in turn connected to the free end of the piston rod of the hydraulic pump 24.

The horizontal rod is situated at a small distance above the level of the upper surface of the horizontal sections of the side supports, i.e. a gap of a few centimetres is left between the ends of the side supports and the horizontal sections. The gaps make it possible to tilt the seat 14 sideways, whereby the rocker shaft 20 attached to the seat rotates around its longitudinal axis. Simultaneously, the horizontal rod 36 attached to the rocker shaft tilts in the tilting direction of the seat. The seat can tilt so far that the free end of the horizontal rod hits the surface of the horizontal section of the side support 19a, 19b. The horizontal rod and side supports thus together form a limiter, which sets an upper limit to the sideways tilting of the seat. In the upper surfaces of the horizontal sections there are damping pillows 46, which prevent the metal parts from bumping together at the end stage of the rocking motion of the seat. Instead of damping pillows, for example a coil spring can be used as a damping member. In the ends of the horizontal rod there are adjusting screws, the protruding end of which hits the first damping pillow when tilting the horizontal rod. Suitable limit values can be set for the sideways tilting of the horizontal rod and seat by rotating the adjusting screws.

In FIG. 2a the seat is in the horizontal position. When more force is directed onto the right half of the seat 14 or the right armrest than onto the left half or armrest, the seat tilts into the position shown in FIG. 2b. Correspondingly, when more force is directed onto the left half of the seat or left armrest, the seat tilts into the position shown in FIG. 2c. The seat can thus be tilted back and forth in the sideways direction by moving the centre of gravity of the person on the seat in turn to different sides of the turning axis. Even a weak person can often control their upper body so much that moving the centre of gravity is successful without assistance. The seat can also be tilted by directing force in turn to the armrests on different edges of the sitting level. The force to be directed onto the armrests can be produced either by the person to be lifted himself, or by some other person assisting in the lifting event.

In the person hoisting device presented in FIGS. 1a-1c and FIGS. 2a-2c, the rocker shaft is substantially perpendicular to the direction of the edge pillars of the frame. The rocker shaft is thus substantially horizontal when the person hoisting device is in the conventional use position and the seat is raised by tilting the seat around the horizontal axis. The invention can also be implemented so that the rocker shaft is arranged in a substantially parallel position with the edge pillars and the seat is attached directly or indirectly to the rocker shaft. The rocker shaft is thus substantially vertical when the person hoisting device is in the conventional use position. The hydraulic pump and the lever mechanism connecting the hydraulic pump and the seat are in this embodiment arranged in a horizontal position and the pump is used by rotating the seat back and forth in the horizontal position.

FIG. 3a shows as an example an advantageous embodiment of a person hoisting device according to the invention as seen from the side. FIGS. 3b, 3c and 3d show a part of the embodiment shown in FIG. 3a seen from behind, shown from sectional line B-B. The embodiment shown in the figures has the same kind of frame 110, auxiliary frame 118, seat 114, armrests 116, hydraulic cylinder 122 and hydraulic pump 124 equipped with a hydraulic fluid container as the invention described above. The embodiment shown in the figures differs from the above-described invention in that the seat 114 is attached in an immobile manner to the auxiliary frame 118, i.e. the seat can not be tilted sideways. The armrests 116 set on the side of the seat are attached to the ends of the horizontal rod 136. In this embodiment, the armrests are tilted in turn from one side to the other, by directing onto them in turn the weight of the person sitting on the seat or force produced by an outside person. Directing force onto the armrests makes the horizontal rod tilt around the rocker shaft 120, whereby the hydraulic pump 124 pumps hydraulic fluid into the hydraulic cylinder 122, which makes the seat rise. During the back-and-forth rocking movement of the armrests, the seat stays all the time in an immobile position in relation to the auxiliary frame 118.

FIGS. 4a, 4b and 4c show as an example a part of a second advantageous embodiment of the person hoisting device according to the invention as seen from behind. The embodiment shown in the figures has a frame 210 as described above, an auxiliary frame 218 supported on the frame in a moveable manner, and a seat 214 attached in a turning manner to the auxiliary frame by means of a rocker shaft 220, which seat has armrests 216. The first end of the rocker shaft is attached to the backrest of the seat 214 and the second end of the rocker shaft is attached in an unrotatable manner to the middle part of the horizontal rod 236. Only the upper part of the frame is shown in the figures.

The person hoisting device shown in the figures has mechanical moving means instead of the hydraulically operated moving means for the seat presented above. A gear rack 26, which has indentation on the opposite long sides, is attached to the end beam 204 connecting the upper ends of the edge pillar 206a, 206b of the frame 210. Two elevator arms 28 are attached to the horizontal rod 236, in the first end of which elevator arms there is a gripping point 30. The elevator arms are placed on the indented sides of the gear rack, so that the gripping points settle in the cogs of the gear rack. The elevator arms are attached by their second end with pivot pins to the horizontal rod and connected together with a spring 31, the tensioning force of which prevents the gripping points from detaching from the gear rack.

In FIG. 4a the seat is in the horizontal position. When more force is directed onto the left half of the seat or the left armrest than onto the right half or armrest, the seat tilts into the position shown in FIG. 4b. Correspondingly, when more force is directed onto the right half of the seat or right armrest, the seat tilts into the position shown in FIG. 4c. With each tilting of the seat, the gripping point 30 of the elevator arm 28 on the rising edge's side of the seat moves up along the gear rack to the next cog, i.e. the auxiliary frame 218 and the thereto attached seat rise upwards. The mechanical moving means shown in the figures additionally comprise a release member, with the aid of which the gripping points of both elevator arms can be moved away from the surface of the gear rack, whereby the auxiliary frame and thereto attached seat descend downwards due to gravity. The mechanism naturally further comprises a brake member, with which the movement of the descending seat is slowed down and the free fall of it toward the base is prevented (the release member and brake member are not shown in the figures).

In the embodiment shown in FIGS. 4a, 4b and 4c both the seat and the armrests are supported on the auxiliary frame so that they can rotate around the rocker shaft. The embodiment can also be implemented in the manner shown in FIGS. 3a-3d, whereby the seat is attached to the auxiliary frame in an immobile manner and the armrests 216 are supported on the horizontal axis 236 turning around the rocker shaft 220.

The person hoisting device presented above is meant especially as an aid for persons with weak lower limbs and/or elderly people. With the aid of the person hoisting device, a weak person who has fallen on the floor can get up off the floor into a standing position on his own. Getting up off the floor takes place with a person hoisting device equipped with a seat and armrests in the following way: The person who has fallen on the floor moves along the floor close to the person hoisting device and lowers the auxiliary frame and thereto attached seat to its lowest end position close to the floor surface. Thereafter the person sidles to sit on the seat. After getting up on the seat, the person starts to tilt the seat and/or armrests by moving the centre of gravity of his upper body in turn to different sides of the centre line of the seat and/or to the armrests on different sides of the centre line. Tilting the seat and/or armrests makes the moving mechanism raise the seat and the person on it upwards in the direction of the edge pillars of the frame. If there is another person present in addition to the person getting up, this person can if so desired assist the getting up by tilting the armrests. When the seat has risen to a sufficient height, the tilting of the seat and/or armrests is stopped. The person can keep sitting on the person hoisting device or he can slide off the seat into a standing position supported by his legs.

The frame and auxiliary frame of the person hoisting device according to the invention can be manufactured from any material suited for the purpose, such as steel, aluminium or a composite material. Material choices can be used to affect the manufacturing costs and weight of the person hoisting device, which weight directly affects how easily the person hoisting device is moved. In order to make moving it easier, it is advantageous to equip the frame with wheels, which can be locked in an unrotatable position, when the person hoisting device is used for getting up. The person hoisting device can with curtains be made to outwardly look like a conventional piece of furniture. Such a person hoisting device can be used as a normal chair, when it is not needed for aiding in getting up.

Some advantageous embodiments of the person hoisting device and method according to the invention have been described above. The invention is not limited to the solutions described above, but the inventive idea can be applied in different ways within the scope of the claims.

1. A person hoisting device, which has a frame, a person support arranged to be moveable in relation to the frame, the position of which person support in relation to the frame can be changed, and moving means for moving the person support from a first location in relation to the frame to a second location in relation to the frame along a movement path, which second location is at a distance from the first location, which moving means are arranged to move the person support in the direction of the movement path when changing the position of the person support in relation to the frame, wherein it comprises an auxiliary frame supported on the frame in a moveable manner, and a rocker shaft supported in a rotatable manner on the auxiliary frame, to which rocker shaft the person support is attached.

2. The person hoisting device according to claim 1, wherein said person support comprises a seat.

3. The person hoisting device according to claim 1, wherein said person support comprises an armrest.

4. The person hoisting device according to claim 1, wherein the movement path of the person support is substantially straight and the rocker shaft is substantially perpendicular to the direction of the movement path.

5. The person hoisting device according to claim 1, wherein the rocker shaft is in a substantially horizontal position, when the person hoisting device is in the use position.

6. The person hoisting support according to claim 1 wherein the person support has a width direction and the rocker shaft is beneath the person support substantially in the middle of the person support, when the person hoisting device is in the use position.

7. The person hoisting device according to claim 1, wherein it further comprises a limiter for limiting the rotation of the rocker shaft.

8. The person hoisting device according to claim 1, wherein it further comprises a locking member for locking the person support in an immobile manner to the auxiliary frame.

9. The person hoisting device according to claim 1, wherein said moving means comprise a hydraulic cylinder (22, 122), which is attached by its first end to the frame and by its second end to the auxiliary frame, a hydraulic pump for pumping hydraulic fluid to the hydraulic cylinder, and a lever mechanism between the person support and the hydraulic pump for using the hydraulic pump by changing the position of the person support.

10. The person hoisting device according to claim 1, wherein said moving means comprise a gear rack, which is attached by its first end to the frame, and at least one elevator arm, which has a first end, by which it is attached to the auxiliary frame, and a second end, which has a gripping point (30) attaching to the gear rack.

11. A method for producing motive power of a person hoisting device, which person hoisting device has a frame, a person support which is moveable in relation to the frame, and moving means for moving the person support from a first location in relation to the frame to a second location in relation to the frame along a movement path, which second location is at a distance from the first location, the motive power of which moving means is produced by changing the position of the person support in relation to the frame, wherein the person hoisting device comprises an auxiliary frame which is moveable in relation to the frame, a rocker shaft supported in a rotatable manner on the auxiliary frame, to which rocker shaft the person support is attached, and the motive power of the person hoisting device is produced by tilting the person support.

12. The method according to claim 11, wherein moving means comprise a hydraulic cylinder, which is attached by its first end to the frame and by its second end to the auxiliary frame; and a hydraulic pump for pumping hydraulic fluid to the hydraulic cylinder, and the hydraulic pump is used by changing the position of the person support in relation to the frame.

13. The method according to claim 11, wherein the position of the person support is changed by moving the centre of gravity of the person supported on the person support in relation to the person support.
